(19) United States
(12) Patent Application Publication
(10) Pub. No.: US 2006/0072469 A1
(43) Pub. Date: Apr. 6, 2006

(54) Communication terminal, communication system, and communication method

(75) Inventor: Yuji Tazaki, Kawasaki (JP)

Correspondence Address: Edward A. Pennington;Swidler Berlin Shereff Friedman, LLP, Suite 300, 3000 K Street, N.W., Washington, DC, 20007-5116, US

(73) Assignee: FUJITSU LIMITED

(21) Appl. No.: 11/017,876

(22) Filed: Dec. 22, 2004

(30) Foreign Application Priority Data
Sep. 17, 2004 (JP) 2004-272140

(51) Int. Cl. H04J 3/14

(52) U.S. Cl. 370/242; 370/352

(57) ABSTRACT

A communication terminal that sends a call request to a call control apparatus that transfers the call request received from a calling terminal to a called terminal, comprises: a fault detecting unit that detects a fault when there is no response to the call request sent to the call control apparatus; a retrieval request sending unit that, when the fault is detected, generates a destination retrieval request for inquiring destination information of the called terminal and sends the destination retrieval request to at least one or more communication terminals belonging to a predetermined area; a retrieval response receiving unit that receives a destination retrieval response containing the destination information from the at least one or more communication terminal; and a call request sending unit that generates a second call request using the destination information and sends the second call request to the called terminal.

### BACKGROUND OF THE INVENTION

The present invention relates to a communication terminal, a communication system, and a communication method that obtain destination information of a called party.

Broadband Internet or VoIP (Voice over Internet Protocol) telephones are recently coming into common use. The VoIP is a technique for sending/receiving voice data using an IP network, such as the Internet or an intranet. VoIP telephones utilizing the Internet are called Internet telephones. Telephone services utilizing the VoIP technology on an IP network independent of the Internet may be called IP telephones. Low-priced telephone services can be provided regardless of distance to called parties by converting voice signals to data and utilizing the Internet as part of the communications network.

Under these circumstances, a rapidly increasing number of companies are switching over from extension telephone systems constructed using PBX (Private branch exchange) to VoIP phones to reduce running costs.

FIG. 11 is a diagram showing an example of an extension telephone system using the VoIP. In FIG. 11, a plurality of VoIP terminals 104 used as extensions are provided at offices or branches of a company. The VoIP terminals 104 are accommodated in respective internal networks at the offices/branches 108 and the individual internal networks are connected to an external network. A SIP server 102 is connected to the external network. The SIP server 102 functions as a call control apparatus for the VoIP terminals 104 according to the SIP (Session Initiation Protocol), a call control protocol for the application layer.

When calling another VoIP terminal 104 as a called party, the calling VoIP terminal 104 sends a call request to the SIP server 102. Receiving the call request, the SIP server 102 retrieves an IP address of the other VoIP terminal 104 corresponding to the call destination and transfers the call request to the retrieved IP address. The call request then arrives at the called VoIP terminal 104 and a call for communication between the VoIP terminals 104 (hereinafter referred to as a telephone call) is established. The SIP server 102 manages IP addresses of individual VoIP terminals 104 in this way so that a call request can arrive at the called VoIP terminal even when the calling VoIP terminal 104 does not know the IP address of the destination.

The VoIP terminals 104 require support from the SIP server 102 to establish telephone calls. Therefore the SIP server 102 is required to operate constantly. However, since various faults may occur in a VoIP system, a mechanism is needed to remedy communication troubles between the SIP server 102 and the VoIP terminals 104. An existing measure for dealing with faults requires separately constructing and running a backup server 110 at each company or each office/branch 108.

Each backup server 110 has a function equivalent to that of the SIP server 102. When a communication trouble is present between a VoIP terminal 104 and the SIP server 102, the VoIP terminal 104 can establish a telephone call with another party by sending a call request to the backup server 110.

Known such techniques for dealing with failures when communication with the server device fails are disclosed in the patent documents below, for example:

Patent document 1 discloses a technique of a communications system in which the currently running VoIP server can be switched to a backup VoIP server without delay or interruption.

Patent document 2 discloses a technique of specifying an IP address on the basis of keyword information when the address is not answered to a gatekeeper etc. of a different communication carrier.
[Patent document 1] JP 2003-258837 A
[Patent document 2] JP 2003-249946 A

Though these conventional techniques aim to reduce construction and running costs, the need to construct a backup server at each company or office/branch may incur an increase in the construction costs.

Furthermore, these techniques require works for running the backup servers, e.g. management of telephone numbers. This creates a need for double management of the SIP server at the communication center and the backup servers, leading to increased running costs.

### SUMMARY OF THE INVENTION

The present invention has been made to solve these problems and an object of the invention is to provide a communication terminal, a communication system, and a communication method that are capable of connecting a call between terminals even when the call cannot be established using a call control apparatus, while achieving reductions in costs required for measures taken to remedy faults.

To achieve the above-mentioned object, the present invention provides a communication terminal that sends a call request to a call control apparatus that transfers the call request received from a calling terminal (calling side) to a called terminal (called side), the communication terminal comprising: a fault detecting unit that detects a fault when there is no response to the call request sent to the call control apparatus; a retrieval request sending unit that, when the communication fault is detected, generates a destination retrieval request for inquiring destination information of the called terminal and sends the destination retrieval request to at least one or more communication terminals belonging to a predetermined area; a retrieval response receiving unit that receives a destination retrieval response containing the destination information from the at least one or more communication terminals; and a call request sending unit that generates a second call request using the destination information and sends the second call request to the called terminal.

According to the present invention, the entire configuration can be simplified because there is no need to construct a backup server used when a fault occurs. Also, when the calling terminal receives no response to a call request due to some reason (e.g. a fault of the call control apparatus; or a network fault between the calling terminal and the call control apparatus, between the call control apparatus and the called terminal, or between the called terminal and the calling terminal), the communication terminal can obtain the destination (destination information of the called terminal) from a communication terminal that belongs to the predetermined area. That is, the minimum necessary function can be maintained when a fault occurs.

The communication terminal according to the present invention further includes: a storage unit; a writing unit that, when the call request is received, stores, in a storage unit, destination information of the calling terminal contained in the call request; a retrieving unit that, when the destination retrieval request is received, retrieves the destination information of the called terminal from the storage unit according to the destination retrieval request; and a retrieval response sending unit that generates the destination retrieval response containing the retrieved destination information and sends the destination retrieval response to the calling terminal that sent the destination retrieval request.

According to the present invention, when a call request is received, the storage unit stores the destination information. Accordingly, when a destination retrieval request is received and the storage unit contains the destination information of the called terminal, the destination information can be sent to the calling terminal.

Also, the present invention provides a communication terminal that sends a call request to a call control apparatus that transfers a call request received from a calling terminal to a called terminal, the communication terminal comprising: a retrieval request sending unit that sends, within a predetermined area to which at least one or more communication terminals belong, a destination retrieval request for obtaining destination information of a called terminal; and a call request sending unit that sends the call request to the call control apparatus to call the called terminal when there is no destination retrieval response containing the destination information from the at least one or more communication terminals receiving the destination retrieval request.

According to the invention, a call request for calling a called terminal is sent to the call control apparatus only when the destination information of the called terminal cannot be obtained from the at least one or more communication terminals belonging to the predetermined area, which reduces the load on the call control apparatus. Also, call history stored in each communication terminal can be effectively utilized in the predetermined area to which the at least one or more communication terminals belong.

Also, the present invention includes (i) a calling terminal composed of: a retrieval request sending unit that sends a destination retrieval request for obtaining destination information of a called terminal, within a predetermined area to which at least one or more communication terminals belong; and a retrieval response receiving unit that receives a destination retrieval response containing the destination information from the at least one or more communication terminals that received the destination retrieval request, and (ii) a communication terminal composed of: a storage unit that at least stores destination information of a sender of a call request; a retrieving unit that retrieves the destination information of the called terminal from the storage unit according to the destination retrieval request sent from the calling terminal; and a retrieval response sending unit that generates the destination retrieval response containing the destination information of the called terminal that the retrieving unit retrieved, and that sends the generated destination retrieval response to the calling terminal.

According to the present invention, the calling terminal and the communication terminal in the predetermined area can cooperate to obtain destination information of the called destination terminal.

### DESCRIPTION OF THE DRAWINGS

FIG. 1 is a diagram showing an overall configuration of the present invention.

FIG. 2 is a diagram showing an example of the configuration of an IP telephone device of the invention.

FIG. 3 is an explanatory diagram illustrating how call history is stored.

FIG. 4 is an explanatory diagram showing examples of SIP messages of a backup operation.

FIG. 5 is an explanatory diagram illustrating a normal operation between user terminals and a SIP server.

FIG. 6 is a diagram illustrating an operation example during a backup operation.

FIG. 7 is a diagram illustrating an operation example during the backup operation.

FIG. 8 is a diagram illustrating a method of retrieving a destination IP address.

FIG. 9 is a diagram illustrating a procedure for establishing a telephone call during the backup operation.

FIG. 10 is a diagram illustrating coexistence of a normal operation and the backup operation.

FIG. 11 is a diagram showing a conventional configuration.

### DETAILED DESCRIPTION OF THE INVENTION

An embodiment of the present invention is now described referring to the drawings. The configuration shown by the embodiment is in all aspects illustrative and the present invention is not limited to the configuration of the embodiment.

[Configuration of Communication System]

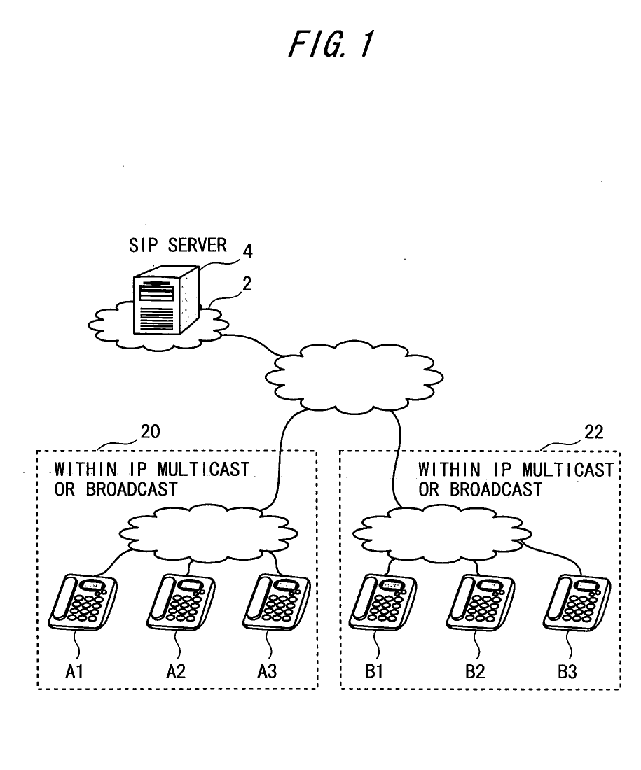

FIG. 1 is a diagram showing an overall configuration of an embodiment of the present invention, where the communication system includes communication terminals. FIG. 1 shows a network 20 to which user terminals A1 to A3 belong, a network 22 to which user terminals B1 to B3 belong, a communication center 2 external to the networks 20 and 22, and a SIP server 4 placed at the communication center 2 and used to establish telephone calls between the user terminals.

Each of the networks 20 and 22 represents an area within which IP multicast packets or broadcast packets can reach. The area in which IP multicast packets can reach is not limited to an area within the same domain like an office or a branch. The SIP server 4 is used to establish telephone calls between user terminals, within a network or between networks.

The IP multicast is a technique for sending messages to a plurality of particular user terminals. The broadcast is a technique for sending messages to all user terminals within the same network (LAN). An area within which IP multicast packets or broadcast packets can reach is hereinafter referred to simply as “a predetermined area”.

In the system shown in FIG. 1, each user terminal establishes a telephone call with another user terminal through the SIP server 4 when there is no communication fault in connection with the SIP server 4. However, when the SIP server 4 has a fault or when there is a fault between a calling user terminal and the SIP server, between the SIP server and a called user terminal, or between a called user terminal and a calling user terminal, a backup operation is performed to establish the telephone call to the destination without through the SIP server 4. The backup operation is an operation that is conducted between user terminals to enable establishment of a telephone call to the destination user terminal. The backup operation will be described later in detail.

Now, the configuration of each device shown in FIG. 1 is described.

<SIP Server>

The SIP server 4 manages IP addresses of the user terminals. The SIP server 4 also functions as a call control apparatus for the user terminals by transferring call requests from calling user terminals to called user terminals according to the SIP which is a call control protocol for the application layer.

When the SIP server 4 receives a call request sent from a user terminal to the SIP server 4, the SIP server 4 retrieves the IP address of the called user terminal and transfers the call request to the retrieved IP address. The call request then arrives at the called user terminal and the telephone call is established between the user terminals.

<User Terminals>

Each user terminal functions as a VoIP terminal that establishes telephone calls with other user terminals using the SIP. Terminals applicable as such user terminals include IP telephones (fixed type and mobile type), personal computers (desktop, notebook, etc.), and the like.

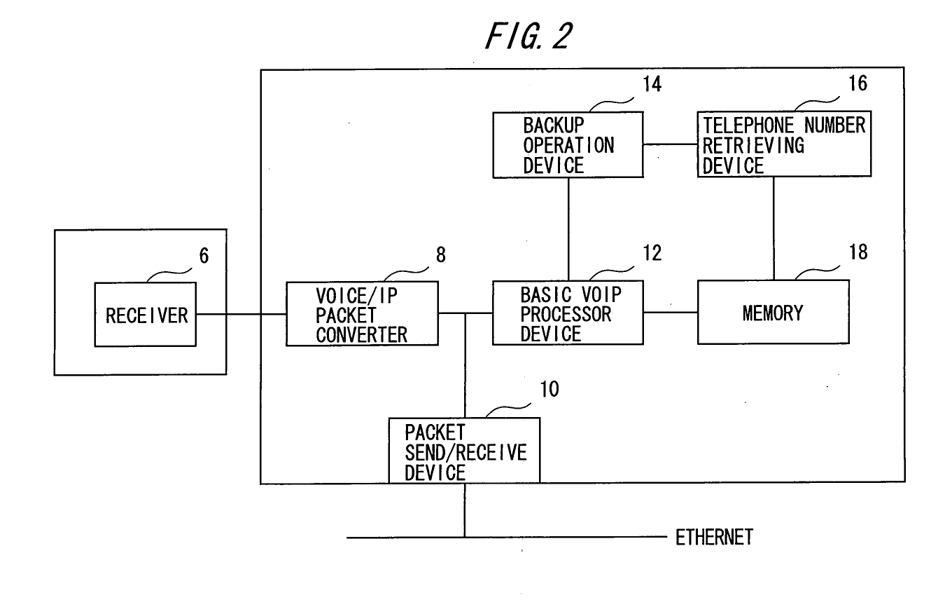

FIG. 2 is a diagram illustrating the configuration of an IP telephone applicable as the user terminal. In FIG. 2, the IP telephone includes a receiver 6 for voice input/output, a voice/IP packet converter 8 for conversion between voice and IP packets, a packet send/receive device 10 for sending/receiving IP packets, a basic VoIP processor device 12 for performing communication management etc., a backup operation device 14 operating in the event of a communication failure, a telephone number retrieving device 16 operating as requested by the backup operation device 14, and a memory 18 for storing destination information from which the telephone number retrieving device 16 retrieves information.

The receiver 6, serving as an interface with a person who makes or receives a call, includes a microphone for voice input, a speaker for voice output, buttons for entry of telephone numbers, and so on. The voice/IP packet converter 8 is a device that converts voice input from the receiver 6 into IP packets and converts IP packets received through a network into voice.

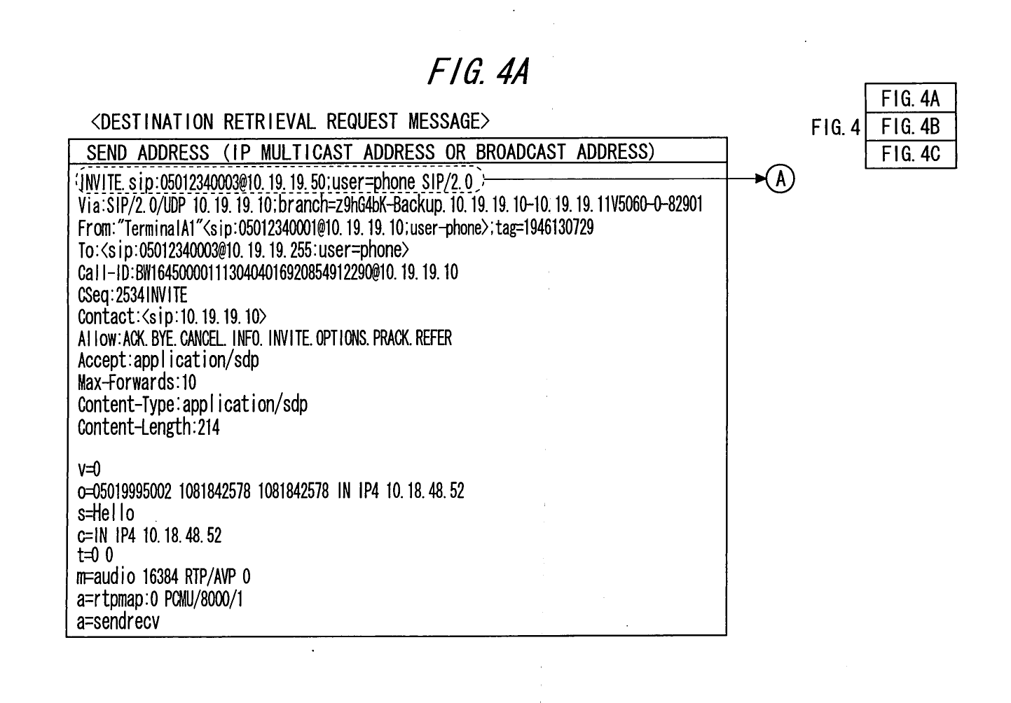

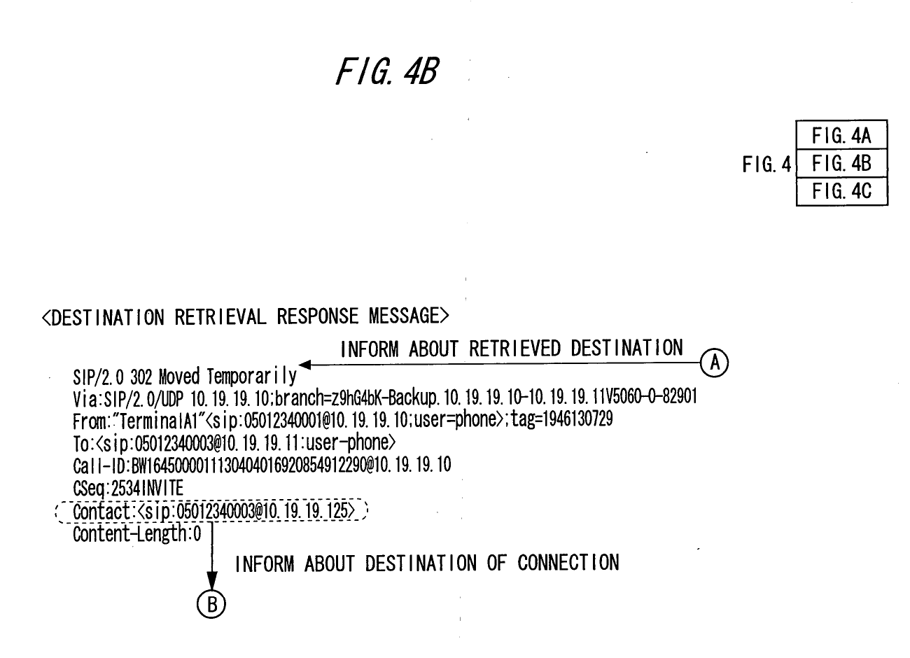

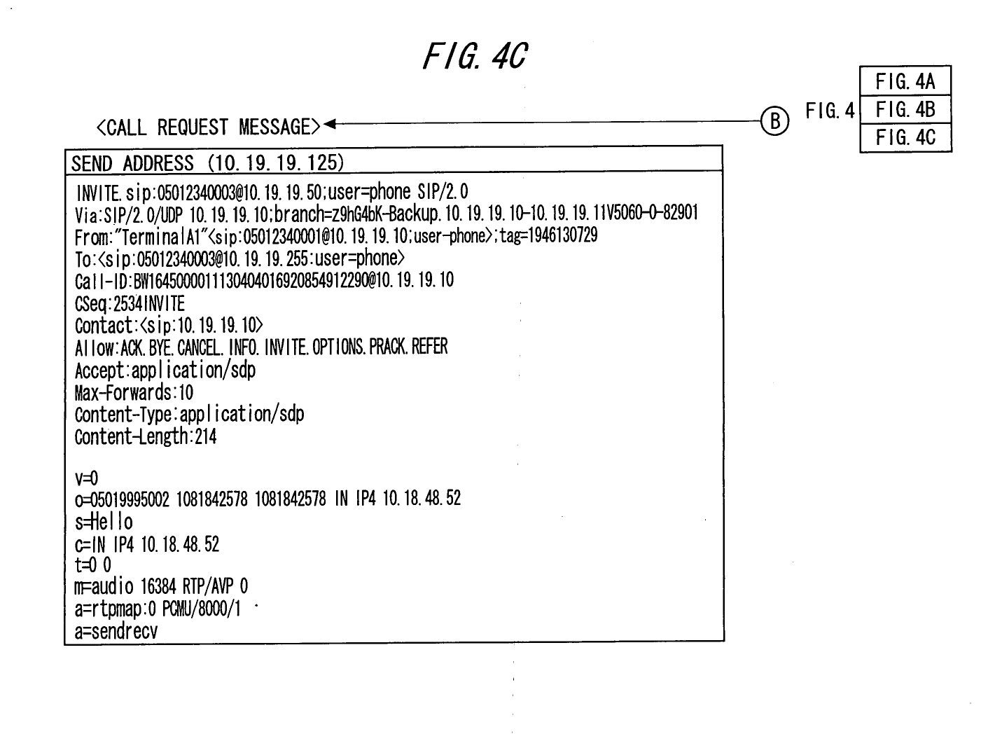

The packet send/receive device 10 forms received frames into IP packets to form SIP messages and RTP (Real-Time Transport Protocol) packets. The SIP messages are as shown in FIG. 4.

The RTP is a protocol for transferring data in real-time. The header of an RTP packet contains information including a time stamp and a sequence number. The time stamp indicates the time at which the packet is sent and the sequence number indicates the order of packet transfer. The RTP packet is sent onto the IP network after being UDP (User Datagram Protocol) packetized and IP packetized.

The basic VoIP processor device 12 processes ordinary communication in the absence of communication fault. The ordinary communication process includes a step of generating a call request message that includes a destination telephone number entered from the buttons of the receiver 6, a step of establishing a telephone call according to a response message to the call request message, and a step of disconnecting the telephone call in response to hanging-up by the user.

The basic VoIP processor device 12 is configured to form call history on the memory 18. When a call request message from another user terminal arrives, the basic VoIP processor device 12 obtains that parties' ID information (e.g. telephone number) and IP address contained in the call request message.

Also, when the terminal receives a response message from a called terminal, the basic VoIP. processor device 12 obtains the IP address of that called terminal. Furthermore, when a call from another user terminal arrives or during a backup operation, the basic VoIP processor device 12 can obtain the IP address of that another user terminal. The basic VoIP processor device 12 writes the IP addresses acquired during calling and called operations to the call history on the memory 18 (which corresponds to “a writing unit” of the invention).

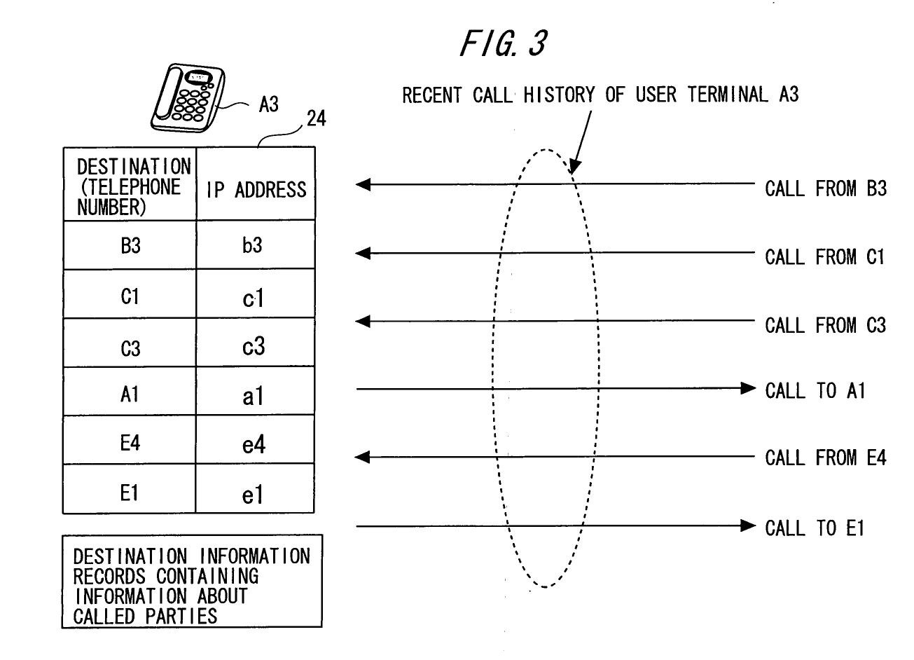

FIG. 3 is an explanatory diagram illustrating the storage of call history. As shown in FIG. 3, a call history table 24 is generated and registered on the memory 18, which contains IP addresses of user terminals to and from which this terminal made or received calls. The IP addresses in the call history table 24 are retrievable, where ID information of the user terminal having the IP address is used as the key for retrieval. The IP addresses are read by the telephone number retrieving device 16 (which corresponds to “a retrieving unit” of the invention). The retrieving key is a SIP address represented as “user name@domain name”.

The call history table 24 contains destination information that is obtained during ordinary connection through the SIP server 4 at the communication center 2 (the ID information of user terminals that sent SIP messages and the IP addresses of the sending user terminals), or destination information that is obtained from user terminals in a predetermined area during backup operations. That is to say, the memory 18 stores history of outgoing calls and incoming calls in the call history table 24.

In FIG. 3, in the call history table 24 in the memory 18, the user terminal A3 stores plural pieces of destination information including the telephone numbers of the user terminals B3, C1, etc. and the IP addresses b3, c1, etc. Each time a call is sent or received, the telephone number and IP address of the other party is added to or updated in the call history table 24 of the user terminal. The call history table 24 may be configured not to store destination information of senders of destination retrieval request messages, since the destination retrieval request messages are sent simultaneously to a plurality of user terminals.

Also, the call history table 24 may set an upper limit of the number of records registered therein, in which case, when the upper limit is exceeded, older records will be eliminated in order. Alternatively, times of registration may also be registered so that records are eliminated when a predetermined time has passed after the registration.

When the basic VoIP processor device 12 detects a communication fault with the SIP server 4 (a fault of the SIP server 4, or a network fault between the user terminal and the SIP server, loss of a call request message, or loss of a call response message), then the backup operation device 14 takes over the process from the VoIP processor device 12 and performs a backup operation.

For example, when the terminal as a calling terminal sent a call request message to the SIP server 4 but receives no response message to the call request message within a predetermined time period (or before a timer runs out), the basic VoIP processor device 12 judges that a fault is present and requests the backup operation device 14 to perform a backup operation (which corresponds to “a fault detecting unit” of the invention). The basic VoIP processor device 12 judges that a communication fault is present when a timeout has occurred a predetermined number of times (once or more).

<Backup Operation>

The backup operation includes an operation as an inquiring terminal and an operation as a responding terminal that responds to an inquiry. As the operation as an inquiring terminal, the backup operation device 14 generates and sends a destination retrieval request message for inquiring the IP address of a user terminal that it desires to call (which corresponds to “a retrieval request sending unit” of the invention). The destination retrieval response message is controlled to be received at user terminals belonging to a predetermined area.

Specifically, in the destination retrieval request message, the backup operation device 14 sets a broadcast address in the destination MAC (Media Access Control) address (send address) or sets an IP multicast address in the destination IP address (send address). Then the destination retrieval request message arrives at user terminals in the predetermined area. The IP address of this terminal is set in the source IP address. The destination retrieval request message is sent from the packet send/receive device 10 onto the network. This terminal can then receive a destination retrieval response message answering the destination retrieval request message.

On the other hand, as the operation as a responding terminal, the backup operation device 14 receives, through the basic VoIP processor device 12, a destination retrieval request message received at the packet send/receive device 10. The basic VoIP processor device 12 judges that the received SIP message is a destination retrieval request message when the received SIP message is a broadcast or IP multicast message and then the basic VoIP processor device 12 sends the destination retrieval request message to the backup operation device 14.

In this case, the telephone number contained in the destination retrieval request message is extracted and given to the telephone number retrieving device 16. The telephone number retrieving device 16 uses the telephone number as the retrieving key to search the call history table 24 on the memory 18 for the IP address that corresponds to the telephone number (which corresponds to “a retrieving unit” of the invention). When the IP address is found and retrieved, the telephone number retrieving device 16 sends the IP address to the backup operation device 14. When the IP address is not found, the telephone number retrieving device 16 informs the backup operation device 14 of the absence of the IP address corresponding to the telephone number and ends the process.

The backup operation device 14 generates and sends a destination retrieval response message that contains the retrieved IP address (which corresponds to “a retrieval response sending unit” of the invention) In the destination retrieval response message, the source IP address of the destination retrieval request message is set as the destination IP address. The destination retrieval response message is sent from the packet send/receive device 10 onto the network and arrives at the user terminal that sent the destination retrieval request message.

In this way, the responding terminal generates a destination retrieval request message when the IP address is stored in the memory 18. On the other hand, when the IP address is not stored in the memory 18, the responding terminal ends the process.

The basic VoIP processor device 12, backup operation device 14, and telephone number retrieving device 16 may be configured as a function realized as a processor not shown (e.g. CPU (Central Processing Unit)) provided in the IP telephone device executes a program stored in the memory 18. Or the basic VoIP processor device 12, backup operation device 14, and telephone number retrieving device 16 may be configured as a dedicated hardware chip or chips for realizing the respective functions.

The IP telephone device introduces a SIP stack to make ordinary call connection and the backup operation can be made executable just by adding the required minimum functions (the backup operation device 14, the telephone number retrieving device 16, etc.) and modifying the basic VoIP processor device 12.

<Messages>

Next, configurations of the destination retrieval request message and the destination retrieval response message generated during a backup operation are described. Each user terminal functions as a SIP terminal that establishes telephone calls according to the SIP. Usually, when a user terminal calls another user terminal, it generates a call request message which is one of SIP messages. The user terminal receiving the call request message sends back a SIP message as a response to the call request message.

This embodiment uses SIP messages as the destination retrieval request message and the destination retrieval response message. FIG. 4 is a diagram showing examples of the destination retrieval request message and the destination retrieval response message.

FIG. 4 shows a destination retrieval request message. In the destination retrieval request message, the source user terminal sets a broadcast address as the destination MAC address or sets an IP multicast address as the destination IP address. As shown in FIG. 4, the destination retrieval request message contains the ID information of the destination to be retrieved (05012340003@10. 191. 19. 50). User terminals that received the destination retrieval request message use the telephone number (ID information) as the key for retrieving the IP address that corresponds to the telephone number.

In the message, the portion starting with INVITE sip: . . . is the same as that of a SIP message that is sent to a destination user terminal through the SIP server 4 (a call request message). When a telephone call is established with a destination user terminal through the SIP server 4, the IP address of the SIP server 4 is set as the send address.

A user terminal that received the destination retrieval request message generates a destination retrieval response message when the IP address corresponding to the telephone number to be retrieved is stored in the memory 18. As shown in FIG. 4, the destination retrieval response message contains the IP address (10. 19. 19. 125) that corresponds to the telephone number to be retrieved (see the Contact header surrounded by broken line). In the destination retrieval response message, the source IP address (10. 19. 19. 10), contained in the destination retrieval request message, is set as the send address and the message is thus sent to the sender.

The source user terminal then receives the destination retrieval response message and extracts, from the Contact header, the IP address (10. 19. 19. 125) that corresponds to the telephone number to be retrieved, and sets the IP address (10. 19. 19. 125) as the send address to generate a call request message. Thus, by using SIP messages, the call request message can be sent to the destination user terminal without using the SIP server 4. In the INVITE SIP-URI of the call request message, sip:05012340003@10. 19. 19. 125 is set using the Contact header contained in the destination retrieval response message.

<Normal Operation>

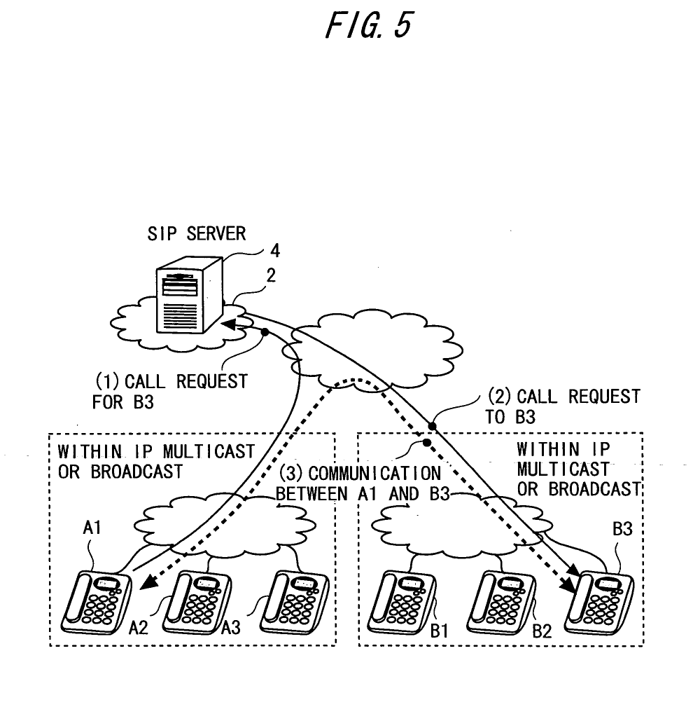

Next, an operation performed in the absence of communication fault between a sending user terminal and the SIP server 4 (normal operation) will be described. FIG. 5 is a diagram showing an example of a normal operation (which uses the SIP server 4).

FIG. 5 shows a normal operation between the SIP server 4 (call control apparatus) at the communication center 2 and the plurality of user terminals A1 to B3. Referring to FIG. 5, an operation for establishing a telephone call between the user terminal A1 and the user terminal B3 is described.

(1) The source user terminal A1 (calling terminal) sends a call request message to the SIP server 4 at the communication center 2 in order to establish a telephone call with the user terminal B3. The SIP server 4 receives the call request message sent from the user terminal A1. Then, the SIP server 4 searches a destination table stored therein using the telephone number contained in the received call request message as the key for retrieval, so as to retrieve the IP address of the destination user terminal (called terminal) that corresponds to the telephone number.

For example, as the destination table, the SIP server 4 manages destination information of the user terminal B3 (for example, the telephone number included in the destination retrieval request message of FIG. 4, i.e. the destination “05012340003@10. 19. 19. 50” and the IP address included in the destination retrieval response message of FIG. 4, “10. 19. 19. 125”).

(2) The SIP server 4 sets the retrieved destination IP address in the send address of the call request message received from the user terminal A1 and sends the call request message to the user terminal B3. The user terminal B3, receiving the call request message, sends a response message to the user terminal A1.

(3) The user terminal A1, receiving the response message from the user terminal B3, can establish a call with the user terminal B3 utilizing the destination information stored in the SIP server 4.

<Backup Operation>

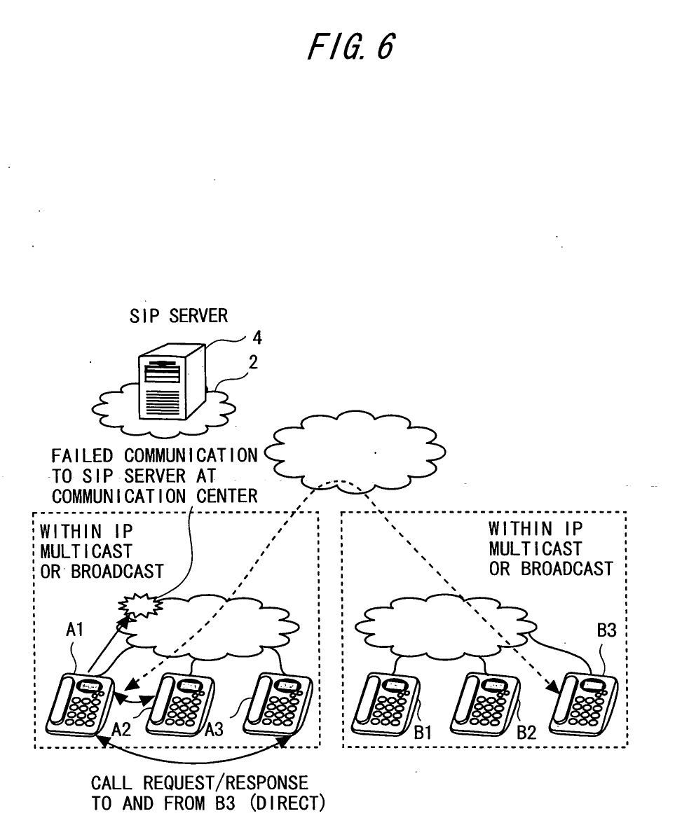

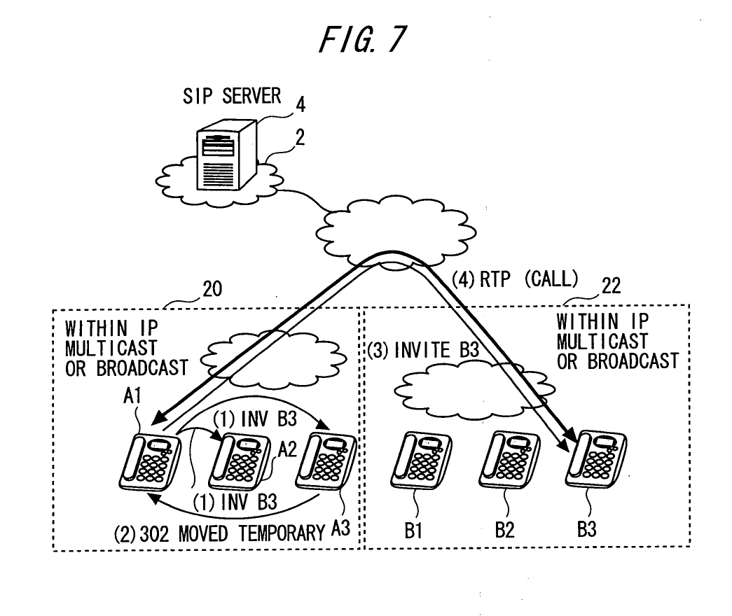

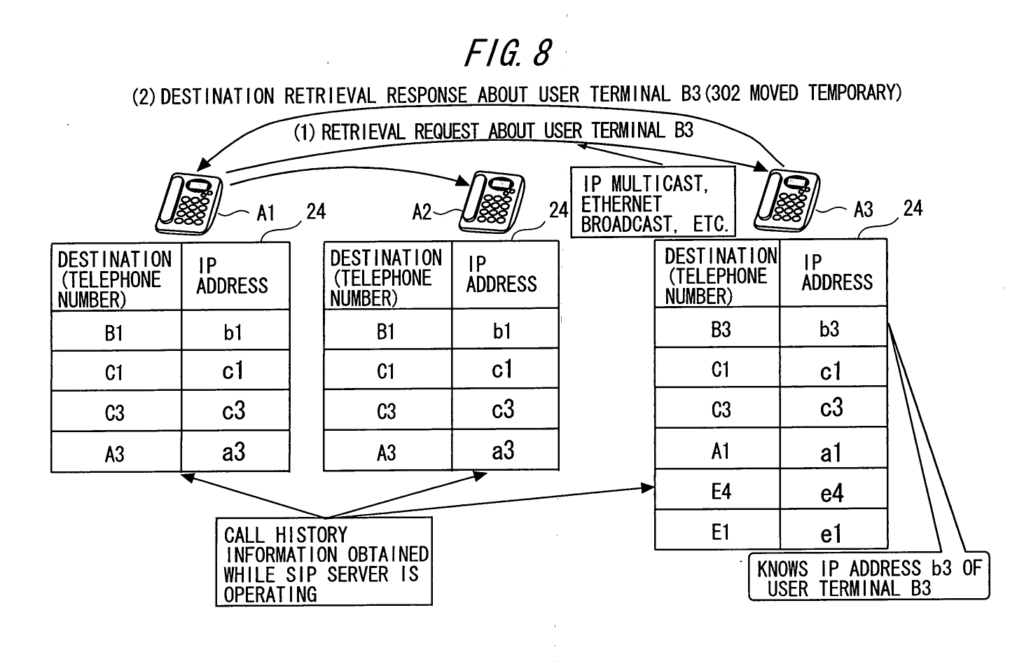

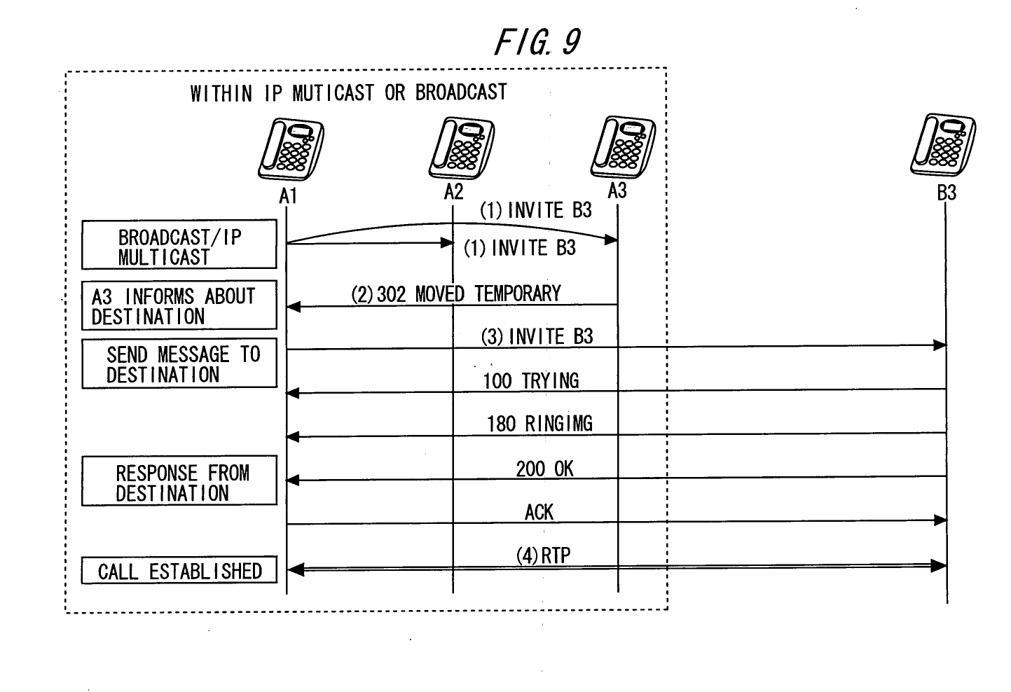

Next, a backup operation performed when a communication fault is present between the SIP server 4 and a calling terminal is described. FIGS. 6 and 7 are diagrams showing an example of the backup operation. FIG. 8 is an explanatory diagram illustrating a method of retrieving the IP address of a destination within a predetermined area and FIG. 9 is a diagram illustrating an example of a procedure for establishing a telephone call between the calling terminal and the called terminal. The numerals (1) to (4) in FIGS. 7 to 9 respectively indicate the same operations.

In FIG. 6, when calling the user terminal B3, the user terminal A1 sends to the SIP server 4 a call request message for the user terminal B3. Then, if the SIP server 4 has a fault or if the link between the user terminal A1 and the SIP server 4 has a fault, the user terminal A1 cannot receive a response message answering the call request message. Then, when a timer for managing acceptance of response message has run out a given number of times, the user terminal A1 starts a backup operation.

The backup operation is an operation that is performed when a call to a destination cannot be established because of a fault between the SIP server 4 at the communication center 2 and a user terminal (an SIP server fault, network fault), wherein the terminal cooperates with user terminals in a predetermined area in order to retrieve the IP address of the destination and establish a telephone call.

As shown in FIG. 7, the user terminal A1 sends a destination retrieval request message to user terminals within a broadcast domain or IP multicast domain. In the example of FIG. 7, a destination retrieval request message for inquiring the IP address of the user terminal B3 is broadcast to the user terminals A2 and A3 belonging to the same network (LAN)(FIGS. 7 to 9: (1)). The destination retrieval request message is generated using a call request message (INVITE) which is one of SIP messages.

Each of the user terminals A2 and A3 receives the destination retrieval request message and then searches the call history table 24 so as to find the IP address that corresponds to the destination telephone number contained in the destination retrieval request message. When the corresponding IP address is retrieved, the user terminal sends a destination retrieval response message containing the IP address, back to the user terminal A1.

As shown in FIG. 8, the memory 18 of each user terminal, A1 to A3, contains a call history table 24, in which IP addresses are stored in association with destinations (telephone numbers). The user terminals A2 and A3 that received the destination retrieval request message (INVITE B3) search their respective call history tables 24.

In the example of FIG. 8, the user terminal A3 has the destination and IP address of the user terminal B3. The user terminal A3 retrieves the IP address of the user terminal B3 using the destination of the user terminal B3 as the retrieval key and sends a destination retrieval response message containing the IP address back to the user terminal A1 (FIGS. 7 to 9: (2)). The destination retrieval response message is generated using one of SIP messages, “302 Moved Temporary”.

As shown in FIG. 9, the user terminal A1 receives the destination retrieval response message from the user terminal A3 and sends a call request message (INVITE B3) to the destination user terminal B3, in which the IP address of the user terminal B3 contained in the destination retrieval response message is set in the send address (FIGS. 7 to 9; (3)).

The basic VoIP processor device 12 in the user terminal A1 extracts the IP address of the destination from the destination retrieval response message and sets the extracted IP address in the send address to generate the call request message, which is sent to the destination (which corresponds to “a call request sending unit” of the invention).

In FIG. 9, numerals under 200 represent tentative responses, which show that the request (INVITE B3) has been received and is being processed (e.g. 100 Trying, 180 Ringing). Numerals 200 and over represent successful responses, which show that the request has been understood and accepted (e.g. 200 OK, 202 Accepted). ACK indicates that the response to the INVITE B3 has been received from the user terminal B3.

Then, when a telephone call (RTP session) is established, the user terminal A1 and the user terminal B3 can communicate with each other by VoIP (FIGS. 7 to 9:(4)).

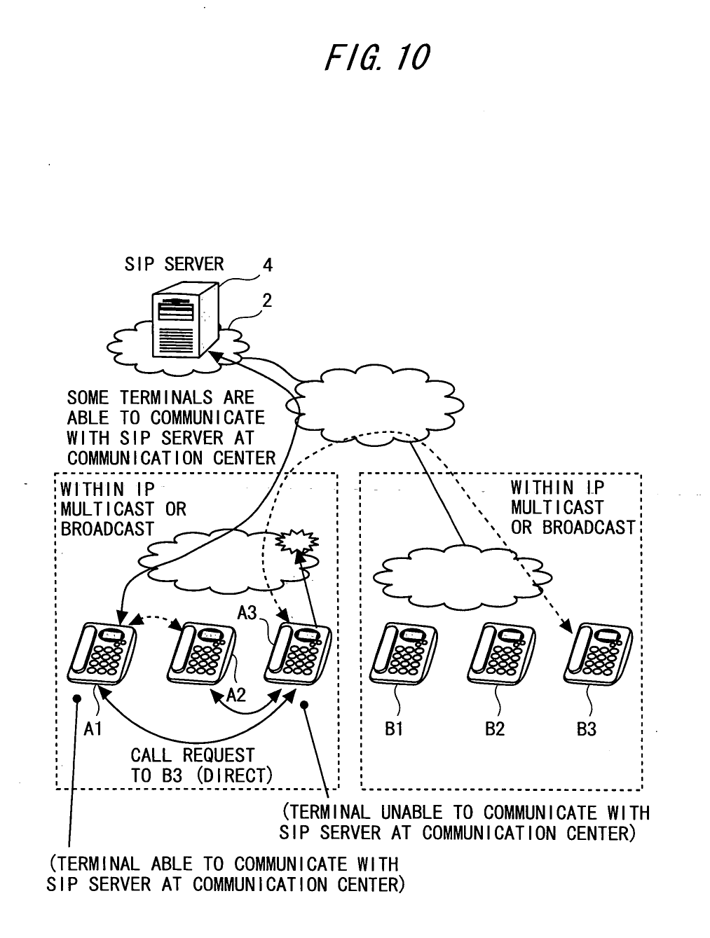

This backup operation described above does not hinder procedures that are performed by other user terminals to establish telephone calls through the SIP server 4. As shown in FIG. 10, for example, a certain user terminal (the user terminal A3 in FIG. 10) cannot establish a telephone call through the SIP server 4 because of a network failure in the route to the SIP server 4. On the other hand, the communication link between the user terminal A1 and the SIP server 4 is normal.

In this case, the user terminal A3 can establish a telephone call with the called terminal (the user terminal B3 in FIG. 10) through the backup operation described above. At the same time, the user terminal A1 can establish a telephone call with the called terminal (the user terminal A2 in FIG. 10) through the SIP server 4. That is to say, the user terminals A1 and A2 are able to simultaneously perform the process of establishing a call between them and the process of responding to the destination retrieval request message from the user terminal A3.

During the backup operation, the cooperation between the user terminal A1 and the user terminal A3 is effected according to the destination IP address or the destination MAC address. Therefore, the operation by the user terminal A1 using the SIP server 4 at the communication center 2 and the operation by the user terminal A3 not using the SIP server 4 can coexist.

The user terminals as communication terminals of the present invention are thus capable of establishing telephone calls without through the SIP server 4 and without such backup servers as described in conventional techniques. This reduces costs for switching extension telephones to IP telephones since there is no need to provide backup servers.

During backup operations, it is not possible to communicate with a party that is not stored in the call history tables 24 as call history information of user terminals in a predetermined area. However, this causes no problem as a temporary remedy because, in a group or an office of a company, frequently used numbers are usually stored in the call histories (including outside lines and extensions). Also, a measure can be taken by increasing the number of records of call history information that can be stored in the call history tables 24.

Furthermore, the backup operation can be effected (or the backup system can be introduced) just by slightly modifying the user terminals or conventional SIP terminals since SIP messages (INVITE, 302 Moved Temporary) are used as messages for obtaining IP addresses of destination user terminals. This also reduces the costs of introduction of the backup system.

Also, because backup operations do not hinder normal operations, the communication system can be constructed so that user terminals performing backup operations and user terminals not performing backup operations can coexist.

[Modifications]

The configuration of the embodiment above can be modified as below.

When a telephone number is entered from the receiver 6, the basic VoIP processor device 12 may search the call history table 24 on the memory 18 for the IP address that corresponds to the telephone number, for the purpose of generating a call request message. Then, when the corresponding IP address is retrieved, the basic VoIP processor device 12 sets the retrieved IP address as the destination IP address in the call request message. This allows the SIP server 4 to be bypassed, which reduces the load on the SIP server 4 and avoids waste of network resources.

Also, before generating a destination retrieval request message as an inquiring terminal operation, the backup operation device 14 may cause the telephone number retrieving device 16 to search for the destination IP address. Then, when the corresponding IP address is not retrieved, the backup operation device 14 generates a destination retrieval request message. This may avoid the need to send a destination retrieval request message and reduces waste of network resources.

Furthermore, as for the area in which the destination retrieval request messages can reach, certain priorities may be set between MAC address and IP multicast address or between a plurality of IP multicast addresses so that the addresses can be used in descending order of priorities.

Also, prior to communication with the SIP server 4, each user terminal may perform an operation of searching for the destination IP address (the operation of sending “a destination retrieval request message”). Then, when no “destination retrieval response message” containing the destination information is received from any user terminal, the user terminal sends a call request message to the SIP server 4.

In this case, a call request for calling the called terminal is sent to the SIP server 4 at the communication center 2 only when the destination IP address cannot be found from any user terminals belonging to a predetermined area. This reduces the load on the SIP server 4. This also enables effective use of the call history stored in each communication terminal in the predetermined area to which at least one or more communication terminals belong.

<Interim Measures for Switch to the System of the Invention>

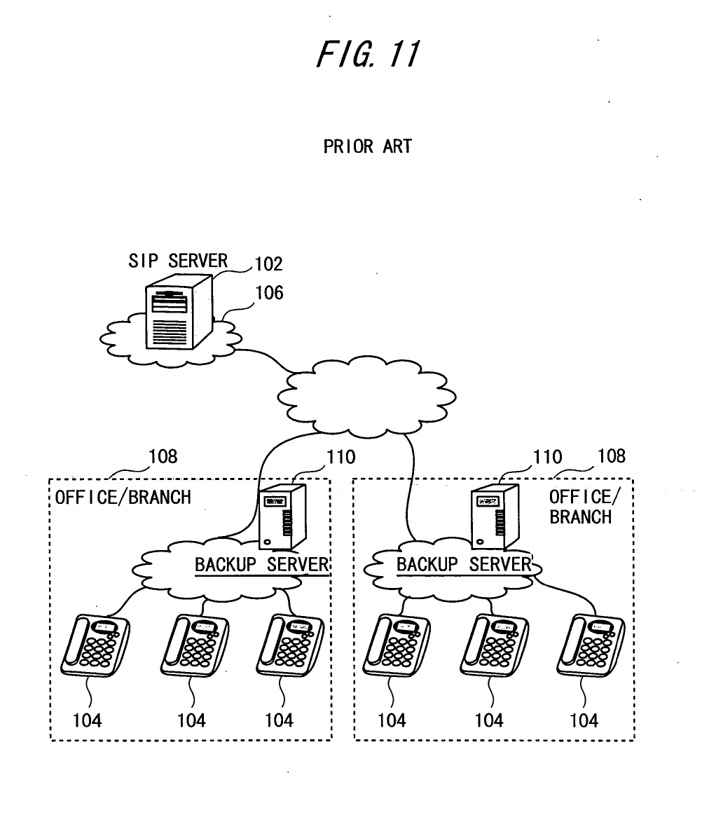

The use of the user terminals of the present invention basically eliminates the need to construct backup servers 110. However, when an existing system is switched to the system of the invention at an office/branch 108 where such an existing backup server 110 is already installed as shown in FIG. 11, an interim measure may be taken so that, as in conventional systems, the inventive user terminals ask the backup server 110 for destination information when a fault occurs in connection with the SIP server 4. Also, the system may be configured so that a plurality of user terminals ask for destination information with each other when a fault occurs between user terminals and the backup server 110.

According to the present invention, even when a call cannot be connected through a call control apparatus, the call can be connected between terminals, while suppressing increase in costs required for measures taken against faults.

1. A communication terminal that sends a call request to a call control apparatus that transfers the call request received from a calling terminal to a called terminal, said communication terminal comprising:
a fault detecting unit that detects a fault when there is no response to the call request sent to the call control apparatus;
a retrieval request sending unit that, when the fault is detected, generates a destination retrieval request for inquiring destination information of the called terminal and sends the destination retrieval request to at least one or more communication terminals belonging to a predetermined area;
a retrieval response receiving unit that receives a destination retrieval response containing the destination information from the at least one or more communication terminal; and
a call request sending unit that generates a second call request using the destination information and sends the second call request to the called terminal.

2. The communication terminal according to claim 1, further comprising:
a storage unit;
a writing unit that, when the call request is received, stores, in the storage unit, destination information of a sender of the call request;
a retrieving unit that, when the destination retrieval request is received, retrieves the destination information of the called terminal from the storage unit according to the destination retrieval request; and
a retrieval response sending unit that generates the destination retrieval response containing the retrieved destination information and sends the destination retrieval response to the calling terminal that sent the destination retrieval request.

3. The communication terminal according to claim 2, wherein when the destination retrieval request is received, the writing unit does not write the destination information contained in the destination retrieval request to the storage unit.

4. The communication terminal according to claim 2, wherein the communication terminal is a SIP terminal that establishes a telephone call according to a SIP (Session Initiation Protocol) through the call control apparatus which is a SIP server, wherein the retrieval request sending unit generates the destination retrieval request message using a SIP message of call request, and wherein the retrieval response receiving unit receives a SIP message as the destination retrieval response message containing an IP (Internet Protocol) address of the called terminal as the destination information.

5. The communication terminal according to any one of claims 1, wherein the retrieval request sending unit sends a destination retrieval request message in which a broadcast address or an IP multicast address is set as a destination address.

6. The communication terminal according to claim 1, further comprising a storage unit that stores the destination information of a sender of the destination retrieval response received by the retrieval response receiving unit.

7. The communication terminal according to claim 1, wherein the call control apparatus is a SIP server that belongs to an external network other than a network to which the communication terminal belongs, or a backup server in the network to which the communication terminal belongs.

8. The communication terminal according to claim 1, wherein the destination information includes a telephone number and an IP address of the called terminal.

9. A communication terminal, comprising:
a retrieval request sending unit that sends a destination retrieval request for obtaining destination information of a called terminal which receives a call request, within a predetermined area to which at least one or more communication terminals belong; and
a call request sending unit that, when there is no destination retrieval response containing the destination information from the at least one or more communication terminals receiving the destination retrieval request, sends a call request for calling the called terminal to a call control apparatus that transfers the call request received from a calling terminal to the called terminal.

10. The communication terminal according to claim 9, further comprising a storage unit that stores the destination information that is contained in a response from the called terminal answering the sent call request.

11. The communication terminal according to claim 9, wherein the predetermined area to which the at least one or more communication terminals belong is an area in which a broadcast packet or an IP multicast packet reaches.

12. A communication system comprising:
a calling terminal which includes:
a retrieval request sending unit that sends a destination retrieval request for obtaining destination information of a called terminal, within a predetermined area to which at least one or more communication terminals belong; and
a retrieval response receiving unit that receives a destination retrieval response containing the destination information from the at least one or more communication terminals that received the destination retrieval request; and
the communication terminal which includes:
a storage unit that at least stores destination information of a sender of a call request;
a retrieving unit that retrieves the destination information of the called terminal from the storage unit according to the destination retrieval request sent from the calling terminal; and
a retrieval response sending unit that generates the destination retrieval response containing the destination information of the called terminal that the retrieving unit retrieved, and that sends the generated destination retrieval response to the calling terminal.

13. The communication system according to claim 12, wherein the calling terminal sends the destination retrieval request within the predetermined area to which the at least one or more communication terminals belong, when the calling terminal sent a call request for calling the called terminal to a call control apparatus that transfers the call request to the called terminal, but receives no response answering the call request.

14. The communication system according to claim 12, wherein when the calling terminal receives no destination retrieval response containing the destination information from the at least one or more communication terminals that received the destination retrieval request, the calling terminal sends the destination retrieval request to the call control apparatus.

15. The communication system according to claim 12, wherein the calling terminal further includes a storage unit for storing the destination information, and when the destination information of the called terminal is not stored in the storage unit, the calling terminal sends the destination retrieval request to the call control apparatus or in the predetermined area to which the at least one or more communication terminals belong.

16. A communication method that sends a call request to a call control apparatus that transfers a call request received from a calling terminal to a called terminal, the method comprising:
a fault detecting step of detecting a fault when there is no response to the call request sent to the call control apparatus;
a retrieval request sending step of, when the fault is detected, generating a destination retrieval request for inquiring destination information of the called terminal and sending the destination retrieval request to at least one or more communication terminals belonging to a predetermined area;
a retrieval response receiving step of receiving a destination retrieval response containing the destination information from the at least one or more communication terminals; and
a call request sending step of generating the call request using the destination information and sending the call request to the called terminal.

17. The communication method according to claim 16, further comprising:
a writing step of, when the call request is received, storing, in a storage unit, destination information of the calling terminal contained in the call request;
a retrieving step of, when the destination retrieval request is received, retrieving the destination information of the called terminal from the storage unit according to the destination retrieval request; and
a retrieval response sending step of generating the destination retrieval response containing the retrieved destination information and sending the destination retrieval response to the calling terminal that sent the destination retrieval request.

18. The communication method according to claim 17, wherein when the destination retrieval request is received, the writing step does not write the destination information contained in the destination retrieval request to the storage unit.

19. The communication method according to claim 17, wherein the communication terminal is a SIP terminal that establishes a telephone call according to a SIP (Session Initiation Protocol) through the call control apparatus which is a SIP server, wherein the retrieval request sending step generates the destination retrieval request message using a SIP message for use as a call request, and wherein the retrieval response receiving step receives a SIP message as the destination retrieval response message containing an IP (Internet Protocol) address of the called terminal as the destination information.

20. The communication method according to claim 16, wherein the retrieval request sending step sends the destination retrieval request message in which a broadcast address or an IP multicast address is set as a destination address.

21. The communication method according to claim 16, further comprising a storage step of storing the destination information contained in the destination retrieval response received in the retrieval response receiving step.

22. The communication method according to claim 16, wherein the call control apparatus is a SIP server that belongs to an external network other than a network to which the communication terminal belongs, or a backup server in the network to which the communication terminal belongs.

23. The communication method according to claim 16, wherein the destination information includes a telephone number and an IP address of the called terminal.

24. A communication method, comprising:
a retrieval request sending step of sending a destination retrieval request for obtaining destination information of a called terminal, within a predetermined area to which at least one or more communication terminals belong; and
a call request sending step of, when there is no destination retrieval response containing the destination information from the at least one or more communication terminals receiving the destination retrieval request, sending a call request for calling the called terminal to a call control apparatus that transfers the received call request to the called terminal.

25. The communication method according to claim 24, further comprising a storage step of storing the destination information that is contained in a response from the called terminal answering the sent call request.

26. The communication method according to claim 24, wherein the predetermined area to which the at least one or more communication terminals belong is an area in which a broadcast packet or an IP multicast packet reaches.
